(19) United States
(12) Patent Application Publication
(10) Pub. No.: US 2012/0071127 A1
(43) Pub. Date: Mar. 22, 2012

(54) AUTOMATIC GAIN CONTROL DEVICE, RECEIVER, ELECTRONIC DEVICE, AND AUTOMATIC GAIN CONTROL METHOD

(75) Inventors: Satoshi TSUKAMOTO, Osaka (JP); Eiji Okada, Osaka (JP); Yasuo Oba, Shiga (JP); Takaharu Saeki, Osaka (JP)

(73) Assignee: Panasonic Corporation, Osaka (JP)

(21) Appl. No.: 13/305,111

(22) Filed: Nov. 28, 2011

Related U.S. Application Data
(63) Continuation of application No. PCT/JP2010/006197, filed on Oct. 19, 2010.

(30) Foreign Application Priority Data
Dec. 15, 2009 (JP) 2009-283792

(51) Int. Cl. H04W 52/52

(52) U.S. Cl. 455/234.1

(57) ABSTRACT

An automatic gain control device includes an amplifier which amplifies an input signal based on a gain control signal, and outputs an amplified signal, a converter which converts the amplified signal into a converted signal having a value corresponding to an absolute value of the amplified signal, a peak detector which removes, during a peak detection period, from values of the converted signal, a predetermined number of values which include a maximum value, and determines a peak level of the converted signal after the removing, an error calculator which calculates an error between the peak level and a reference signal, and outputs the error as an error signal, and a gain controller which updates the gain control signal based on the error signal, and outputs an updated gain control signal.

### CROSS-REFERENCE TO RELATED APPLICATION

This is a continuation of PCT International Application PCT/JP2010/006197 filed on Oct. 19, 2010, which claims priority to Japanese Patent Application No. 2009-283792 filed on Dec. 15, 2009. The disclosures of these applications including the specifications, the drawings, and the claims are hereby incorporated by reference in its entirety.

### BACKGROUND

The present disclosure relates to automatic gain control devices, automatic gain control methods, etc. used for radio receivers etc.

In a circuit such as a receiver, it is important to keep a signal level within an appropriate range in order to effectively utilize the dynamic range while avoiding saturation. Also, when an analog signal is digitized, it is also important to keep the level of a signal input to an analog-to-digital converter (ADC) within an appropriate range. The level of a signal received by a radio receiver varies over a wide range depending on various channel propagation conditions such as multipath fading and shadowing. Accordingly, many radio receivers each keep the level of a received signal within a desired range by using an automatic gain control device (AGC).

An automatic gain control device automatically adjusts the gain of a gain-controlled amplifier (GCA) based on the level of the input signal to keep the level of an output signal constant. In other words, an automatic gain control device controls the gain of a GCA so that the gain will be inversely proportional to the maximum value of the input signal, and thus keeps the level of an output signal constant.

Examples of a device which controls the gain have been known. For example, Patent Document 1 describes a receiver which blocks a signal when the level of an output signal exceeds a reference level. Patent Document 2 describes a level control system which attenuates an input signal based on the amplitude of an output signal.

The referenced Patent Documents are as follows:

Patent Document 1: Japanese Patent Publication No. H01-227529

Patent Document 2: U.S. Pat. No. 4,514,703

### SUMMARY

However, when the input signal includes impulse noise, the device described in Patent Document 1 or 2 incorrectly decides that the value of a peak of the impulse noise, not the actual maximum value of the input signal, is the maximum value. The adjustment of the amplifier gain is performed so that an error signal, which is a difference between the maximum value and a reference signal, will be zero, that is, so that the maximum value will match the magnitude of the reference signal. Accordingly, even when the actual signal level is constant, the gain may become unstable or too low.

In particular, in a receiver such as a car radio, highly steep impulse noise is added to a received signal upon ignition of an automobile, upon actuation of a power mirror, etc. Such noise has a very small pulse width, but may have a peak level several tens dB higher than the level of the signal without impulse noise.

It is an object of the present invention to provide automatic gain control with excellent tracking performance even if an input signal includes impulse noise.

An automatic gain control device according to an example embodiment of the present invention includes an amplifier configured to amplify an input signal based on a gain control signal, and to output an amplified signal, a converter configured to convert the amplified signal into a converted signal having a value corresponding to an absolute value of the amplified signal, a peak detector configured to remove, during a peak detection period, from values of the converted signal, a predetermined number of values which include a maximum value, and determine a peak level of the converted signal after the removing, an error calculator configured to calculate an error between the peak level and a reference signal, and to output the error as an error signal, and a gain controller configured to update the gain control signal based on the error signal, and to output an updated gain control signal.

Thus, the effects of impulse noise can be eliminated, and therefore the peak level corresponding to an output signal of the amplifier can be correctly measured.

A receiver according to an example embodiment of the present invention includes an automatic gain control device and a demodulator. The automatic gain control device includes an amplifier configured to amplify an input signal based on a gain control signal, and to output an amplified signal, a converter configured to convert the amplified signal into a converted signal having a value corresponding to an absolute value of the amplified signal, a peak detector configured to remove, during a peak detection period, from values of the converted signal, a predetermined number of values which include a maximum value, determine a peak level of the converted signal after the removing, and output noise position information indicating a timing of impulse noise, an error calculator configured to calculate an error between the peak level and a reference signal, and to output the error as an error signal, and a gain controller configured to update the gain control signal based on the error signal, and to output an updated gain control signal. The demodulator includes a noise canceller, and demodulates the amplified signal, and outputs a demodulated signal; and the noise canceller removes noise from a signal in the demodulator using the noise position information.

An electronic device according to an example embodiment of the present invention includes the receiver, a signal processor configured to perform predetermined signal processing on the demodulated signal output from the receiver, and to output a processed signal, and an output section configured to, at least: display video represented by the processed signal, or output audio represented by the processed signal.

An automatic gain control method according to an example embodiment of the present invention includes amplifying an input signal by an amplifier based on a gain control signal, and obtaining an amplified signal, converting the amplified signal into a converted signal having a value corresponding to an absolute value of the amplified signal, removing, during a peak detection period, from values of the converted signal, a predetermined number of values which include a maximum value, determining a peak level of the converted signal after the removing, calculating an error between the peak level and a reference signal to output the error as an error signal, and updating the gain control signal based on the error signal.

According to the example embodiment of the present invention, the peak value of the signal without impulse noise can be correctly determined even if impulse noise exists. Accordingly, the gain value set in an amplifier can be prevented from not converging and/or becoming too small.

### BRIEF DESCRIPTION OF THE DRAWINGS

FIG. 1 is a block diagram illustrating an example configuration of an automatic gain control device according to an embodiment of the present invention.

FIG. 2 is a graph showing an example of sample values of a signal input to the memory of FIG. 1.

FIG. 3 is a block diagram illustrating another example configuration of the automatic gain control device of FIG. 1.

FIG. 4 is a graph showing an example of sample values of a signal input to the maximum value detector of FIG. 3.

FIG. 5A is a graph showing an example of waveforms of FM signals when impulse noise is added. FIG. 5B is a graph showing changes in gains of an amplifier when one of the signals of FIG. 5A is input to the automatic gain control device of FIG. 3.

FIG. 6 is a graph showing another example of sample values of a signal input to the memory of FIG. 1.

FIG. 7 is a block diagram illustrating still another example configuration of the automatic gain control device of FIG. 1.

FIG. 8A is a graph showing an example of sample values of a signal input to the memory of FIG. 7. FIG. 8B is a graph showing an example of sample values of a signal input to the maximum value detector of FIG. 7.

FIG. 9 is a block diagram illustrating still another example configuration of the automatic gain control device of FIG. 1.

FIG. 10 is a block diagram illustrating still another example configuration of the automatic gain control device of FIG. 1.

FIG. 11 is a block diagram illustrating an example configuration of a radio receiver according to an embodiment of the present invention.

FIG. 12 is a block diagram illustrating an example configuration of an electronic device according to an embodiment of the present invention.

FIG. 13 is a block diagram illustrating an example configuration of an automatic gain control device to which a complex signal is input.

### DETAILED DESCRIPTION

Example embodiments of the present invention will be described below with reference to the drawings, in which reference numbers having the same last two digits indicate components corresponding to one another, and indicate the same or similar components. A solid line between function blocks in the drawings represents an electrical connection.

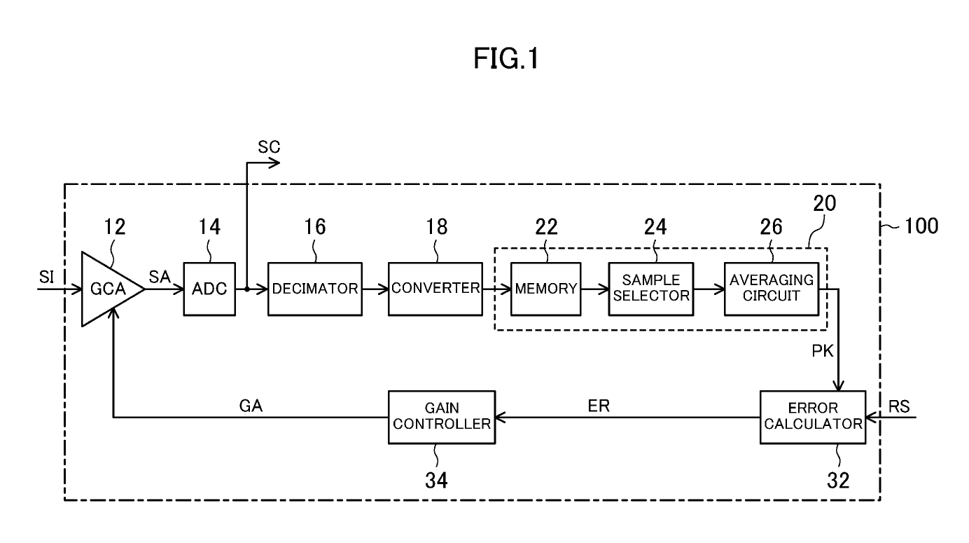

FIG. 1 is a block diagram illustrating an example configuration of an automatic gain control device according to an embodiment of the present invention. The automatic gain control device 100 of FIG. 1 includes a gain-controlled amplifier (GCA) 12, an analog-to-digital converter (ADC) 14, a decimator 16, a converter 18, a peak detector 20, an error calculator 32, and a gain controller 34. The peak detector 20 includes a memory 22, a sample selector 24, and an averaging circuit (averaging unit) 26.

The amplifier 12 amplifies an input signal SI, and outputs an amplified signal SA to the ADC 14. In this process, the amplifier 12 receives a gain control signal GA from the gain controller 34, amplifies the input signal SI based on the gain control signal GA, and outputs an amplified input signal as the signal SA. That is, the amplifier 12 provides the input signal SI with a gain corresponding to the gain control signal GA. Note that, as used herein, the term amplification includes attenuation (a case in which the gain in dB is negative). The ADC 14 performs analog-to-digital conversion on the amplified signal SA, and outputs an obtained digital signal (sample value) SC to the decimator 16 and to the outside of the automatic gain control device 100.

The decimator 16 processes the signal SC output from the ADC 14 by a low-pass filter (not shown), and then converts the signal into a signal of a lower sampling rate by decimating sample values, and outputs the converted signal. The low-pass filter is used to avoid aliasing in the decimation. The converter 18 converts the signal after decimation into a signal having a value corresponding to the magnitude thereof, and outputs the converted signal to the memory 22. For example, the converter 18 includes a squaring circuit or an absolute-value calculation circuit, and converts each of the sample values of the signal after decimation into a value corresponding to each absolute value.

During a peak detection period, the peak detector 20 removes, from the sample values of the converted signal converted by the converter 18, a predetermined number of values which include a maximum value, and determines a peak level PK of the signal without pulse-like noise (impulse noise) among the rest of the values. As used herein, a peak level is a peak value of a signal, or an average over a period including values near the peak value.

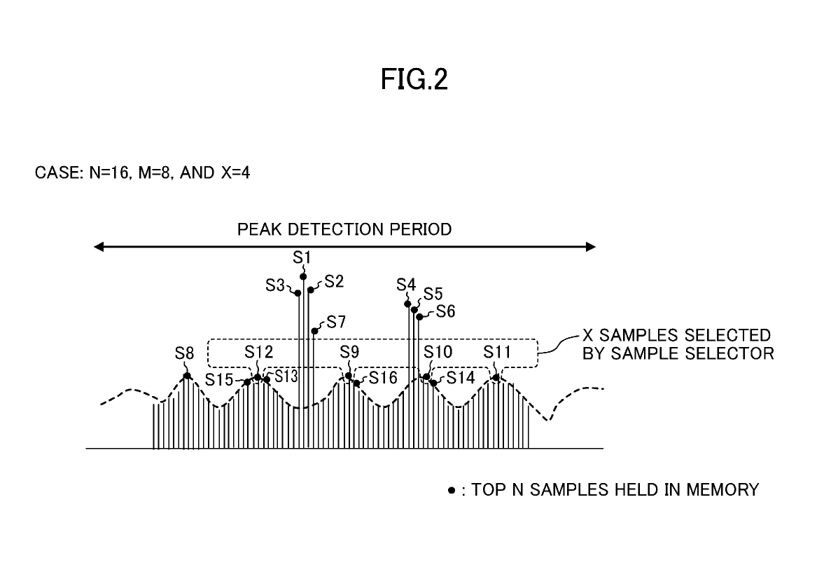

FIG. 2 is a graph showing an example of sample values of the signal input to the memory 22 of FIG. 1. FIG. 2 illustrates an example of when N=16, M=8, and X=4 (where N is an integer greater than or equal to 2, M is a natural number satisfying M<N, and X is a natural number satisfying X≦N−M). The length of each vertical line represents a corresponding sample value output from the converter 18. This representation also applies to the graphs showing sample values shown below. The closed circles S1-S16 represent N highest values in descending order (values of top N samples) out of the values input during the peak detection period. The sample values indicated by the closed circles S1-S7 result from impulse noise.

The memory 22 holds the values of the top N samples among the values in the peak detection period which are input as the converted signals converted by the converter 18. For example, in each time the memory 22 receives a new sample value, the memory 22 determines whether to hold the value or not. That is, it is determined whether or not the new sample value is greater than the minimum value of the N sample values held by the memory 22 at that time. If it is determined that the new sample value is greater than the minimum value, the new sample value is held, replacing the minimum value. Thus, the memory 22 can hold the highest sample values. The samples held in the memory 22 at the end of the peak detection period are represented by the closed circles S1-S16 of FIG. 2.

The sample selector 24 selects the values of the top X samples after removing the values of the top M samples from the values of the N samples held in the memory 22 (i.e., (M+1)-th through (M+X)-th highest samples are selected), and outputs the selected values to the averaging circuit 26 at the end of, or after, the peak detection period. In the case of FIG.

2, the values of eight samples represented by the closed circles S1-S8 are not selected, but the values of four samples represented by the closed circles S9-S12 are selected. The averaging circuit 26 averages the values of the X samples selected by the sample selector 24, and outputs the obtained average as the peak level PK of the peak detection period. The data held in the memory 22 is reset at each end of the peak detection period.

The error calculator 32 calculates an error between the peak level PK obtained by the averaging circuit 26 and a reference signal RS, and outputs the error as an error signal ER. The reference signal RS has an almost constant level. The gain controller 34 updates the gain control signal GA based on the error signal ER, and outputs the updated gain control signal to the amplifier 12. Performing this process in each peak detection period keeps the output signal SA of the amplifier 12 at a substantially constant level dependent on the reference signal RS. It is assumed for purposes of example that the duration of the peak detection period and the period of updating the gain control signal GA are constant.

For example, in the case of FIG. 2, the values of the eight samples represented by the closed circles S1-S8 are not selected. Thus, according to the automatic gain control device 100 of FIG. 1, the effects of impulse noise such as those represented by the closed circles S1-S7 can be eliminated, and therefore the peak level PK corresponding to the signal SA can be correctly measured in each peak detection period. The values of M, N, and X may be configurable, by using a register, from the outside of the automatic gain control device 100 of FIG. 1.

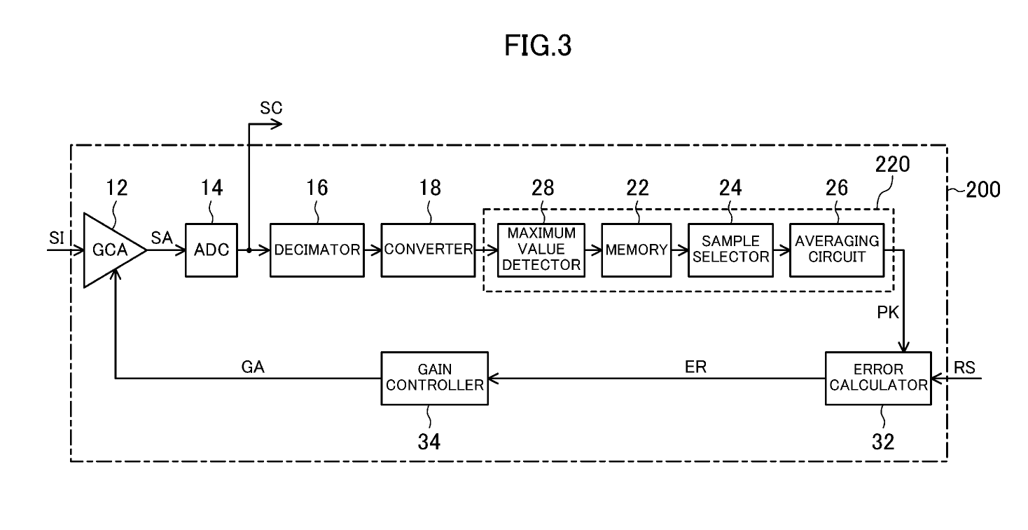

FIG. 3 is a block diagram illustrating another example configuration of the automatic gain control device of FIG. 1. The automatic gain control device 200 of FIG. 3 is configured similarly to the automatic gain control device 100 of FIG. 1 except that the automatic gain control device 200 includes a peak detector 220 instead of the peak detector 20. The peak detector 220 further includes a maximum value detector 28 in addition to the components of the peak detector 20.

In the peak detector 20 of the automatic gain control device 100 of FIG. 1, impulse noise may account for a significantly large number of samples among highest samples in the memory 22 when the sampling interval is short with respect to the duration of impulse noise, or when the peak detection period is long. The automatic gain control device 200 of FIG. 3 is configured so as not to require a memory having a very large capacity even in such a case.

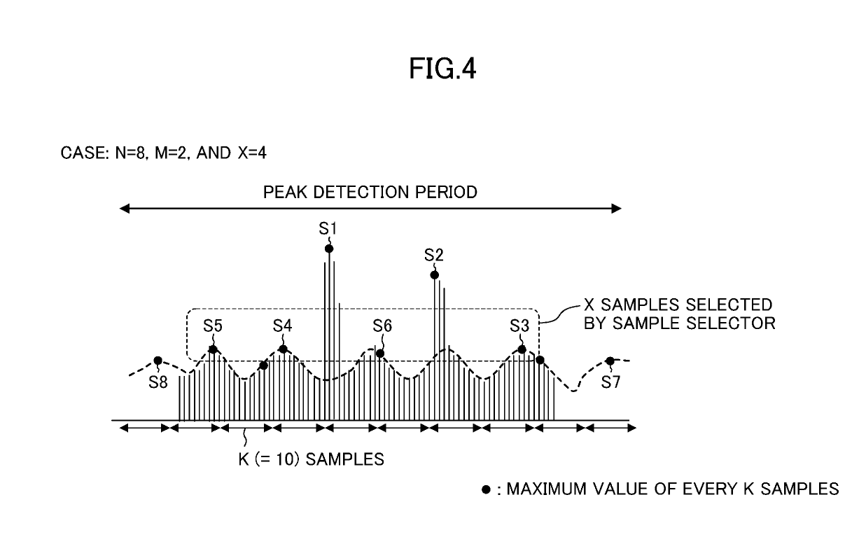

FIG. 4 is a graph showing an example of sample values of a signal input to the maximum value detector 28 of FIG. 3. FIG. 4 illustrates an example of when N=8, M=2, and X=4. The maximum value detector 28 receives the converted signal converted by the converter 18, and outputs the maximum value of the sample values in each short period of a predetermined duration which is shorter than the peak detection period (every K samples, where K is an integer greater than or equal to 2). The memory 22 holds the values of the top N samples among a plurality of maximum values in the peak detection period input from the maximum value detector 28. Each of the closed circles of FIG. 4 represents the maximum value of every K samples, and the closed circles S1-S8 represent the sample values held in the memory 22.

The sample selector 24 selects the values of the top X samples after removing the top M samples from the values of the N samples held in the memory 22 (i.e., (M+1)-th through (M+X)-th samples are selected), and outputs the selected values to the averaging circuit 26 at the end of, or after, the peak detection period. In the case of FIG. 4, the values of two samples represented by the closed circles S1 and S2 are not selected, but the values of four samples represented by the closed circles S3-S6 are selected.

In this example, by using the maximum value detector 28, the sample values resulting from impulse noise having a certain duration are represented by one sample. The maximum value detector 28 outputs sample values to the memory 22 at a sampling rate which is one K-th of the sampling rate of the signal input thereto, thereby causing the number of values stored in the memory 22 to be reduced. Moreover, unlike simple decimation of values, such a process always selects the peak values of a signal. According to the automatic gain control device 200 of FIG. 3, the circuit size can be reduced even when the sampling interval is short compared with the duration of impulse noise, or even when the peak detection period is long.

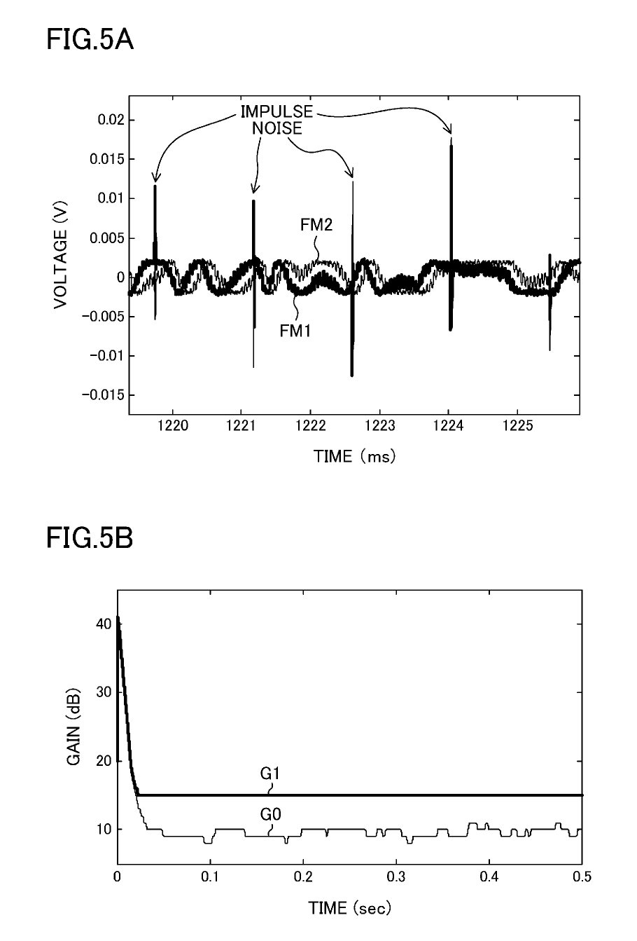

FIG. 5A is a graph showing an example of waveforms of frequency modulation (FM) signals when impulse noise is added. FIG. 5B is a graph showing changes in gains of the amplifier 12 when one of the signals of FIG. 5A is input to the automatic gain control device 200 of FIG. 3.

For example, it is known that a car radio tuner is affected by impulse noise generated upon ignition, upon actuation of a power mirror, etc. FIG. 5A illustrates impulse noise which is added to FM signals FM1 and FM2. As shown in FIG. 5B, if control is provided using only the maximum values during the peak detection period, then the gain after convergence G0 is low, and therefore the signal amplification is not enough. This is because the impulse noise and the signal are indistinguishable, and thus the gain is affected by the impulse noise. Meanwhile, according to the automatic gain control device 200 of FIG. 3, it is shown that the gain after convergence G1 is high and stable, and that the tracking performance is also excellent.

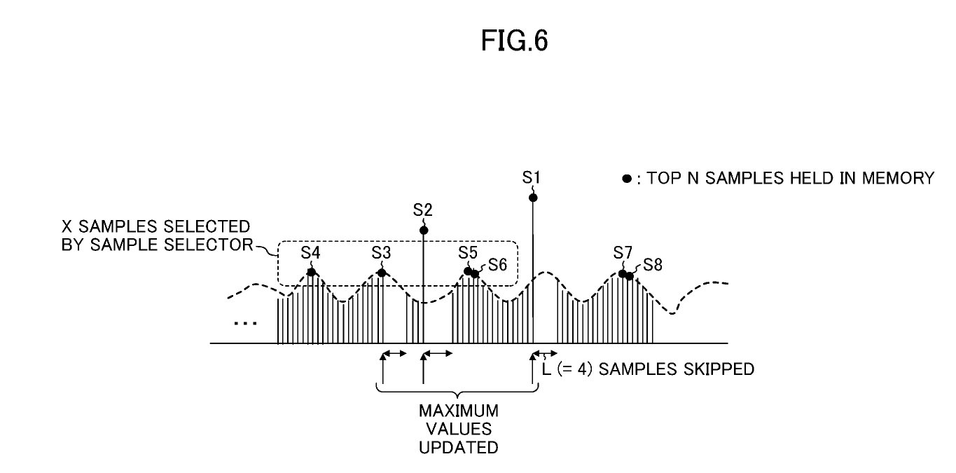

The automatic gain control device 100 of FIG. 1 may operate as follows. Here, another example of the operation of the memory 22 will be described. FIG. 6 is a graph showing another example of sample values of a signal input to the memory 22 of FIG. 1. The memory 22 makes a determination when the memory 22 receives a new value, and always holds the top N samples among the values input, while if the maximum value of the sample values held by the memory 22 is updated with a new value, the process is skipped, and the values of L samples (where L is an integer greater than or equal to 1) input immediately thereafter are not held. FIG. 6 assumes that L=4, and illustrates, by way of example, a case in which N=8, M=2, and X=4, similarly to the case of FIG. 4. The closed circles S1-S8 represent the sample values to be held in the memory 22.

Such an operation of the memory 22 can prevent the memory from being occupied by sample values resulting from same impulse noise after a rising edge of the impulse noise is detected. Therefore, the circuit size can be reduced even when the sampling interval is short compared with the duration of impulse noise, or even when the peak detection period is long. Note that the value L may be configurable, by using a register, from the outside of the automatic gain control device 100.

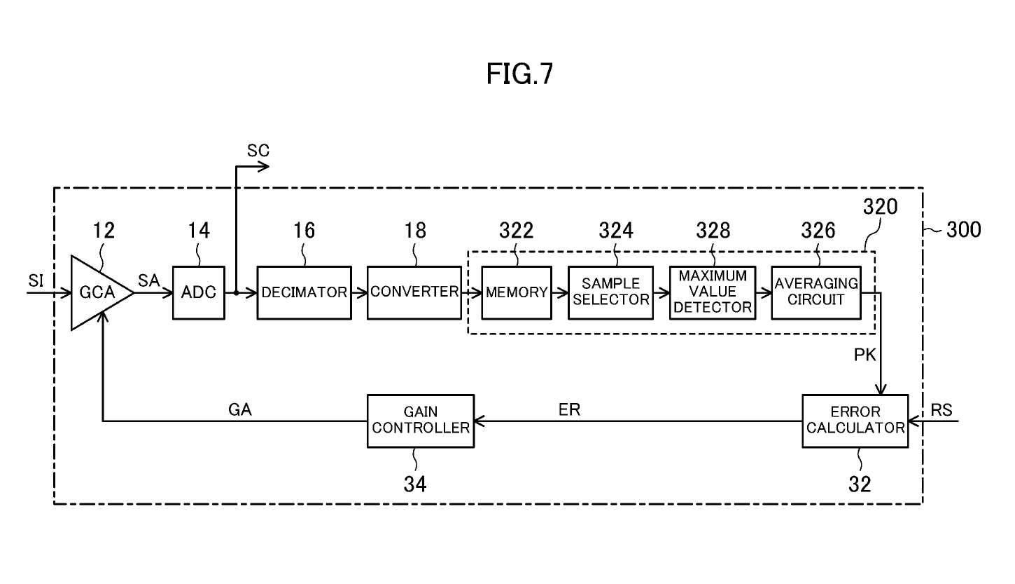

FIG. 7 is a block diagram illustrating still another example configuration of the automatic gain control device of FIG. 1. The automatic gain control device 300 of FIG. 7 is configured similarly to the automatic gain control device 100 of FIG. 1 except that the automatic gain control device 300 includes a peak detector 320 instead of the peak detector 20. The peak detector 320 includes a memory 322, a sample selector 324, an averaging circuit 326, and a maximum value detector 328.

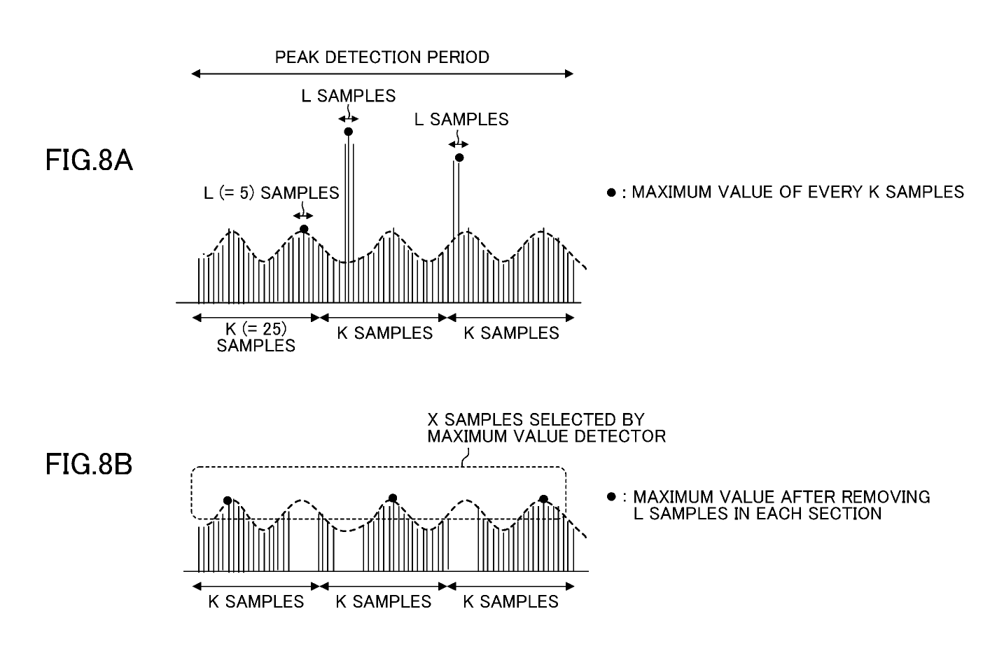

FIG. 8A is a graph showing an example of sample values of the signal input to the memory 322 of FIG. 7. FIG. 8B is a graph showing an example of sample values input to the maximum value detector 328 of FIG. 7.

The memory 322 operates in repeating cycles having a shorter length than the peak detection period (each of the repeating cycles corresponds to K samples). That is, the memory 322 holds the sample values in a period corresponding to K samples input as the converted signal converted by the converter 18, and outputs the held values to the sample selector 324 at the end of, or after, this period. The sample selector 324 selects, from the K samples which are held and output by the memory 322, the sample values other than L sample values which include the maximum value and sample values temporally before and after the maximum value, and then outputs the selected sample values to the maximum value detector 328.

The maximum value detector 328 determines the maximum value from the (K−L) sample values selected and output by the sample selector 324, and outputs the maximum value to the averaging circuit 326. The averaging circuit 326 calculates the average of the plurality of maximum values determined by the maximum value detector 328 during the peak detection period, and outputs the calculated average to the error calculator 32 as the peak level PK. FIGS. 8A and 8B illustrates, by way of example, a case in which K=25 and L=5. According to the automatic gain control device 300 of FIG. 7, the circuit size can be reduced even when the sampling interval is short compared with the duration of impulse noise, or even when the peak detection period is long.

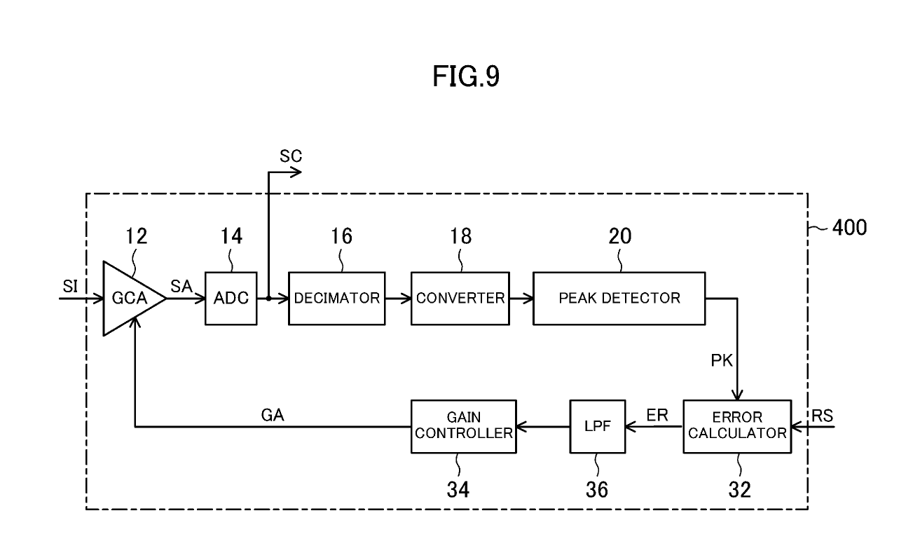

FIG. 9 is a block diagram illustrating still another example configuration of the automatic gain control device of FIG. 1. The automatic gain control device 400 of FIG. 9 is configured similarly to the automatic gain control device 100 of FIG. 1 except that the automatic gain control device 400 further includes a low-pass filter (LPF) 36.

The LPF 36 receives the error signal ER output from the error calculator 32, passes low frequency components of this signal (in other words, smoothes this signal), and outputs the obtained signal to the gain controller 34. The gain controller 34 updates the gain control signal GA based on the signal output from the LPF 36. The LPF 36 is, for example, a first-order infinite impulse response (IIR) filter, and may operate once in each gain update interval. According to the automatic gain control device 400 of FIG. 9, a change of the gain control signal GA due to a small change of the error signal ER caused by false detection in the peak detector 20, by other noise, etc. can be reduced. Similarly, other automatic gain control devices described herein, such as the automatic gain control devices 200 and 300, may each further include the LPF 36, which smoothes the error signal ER.

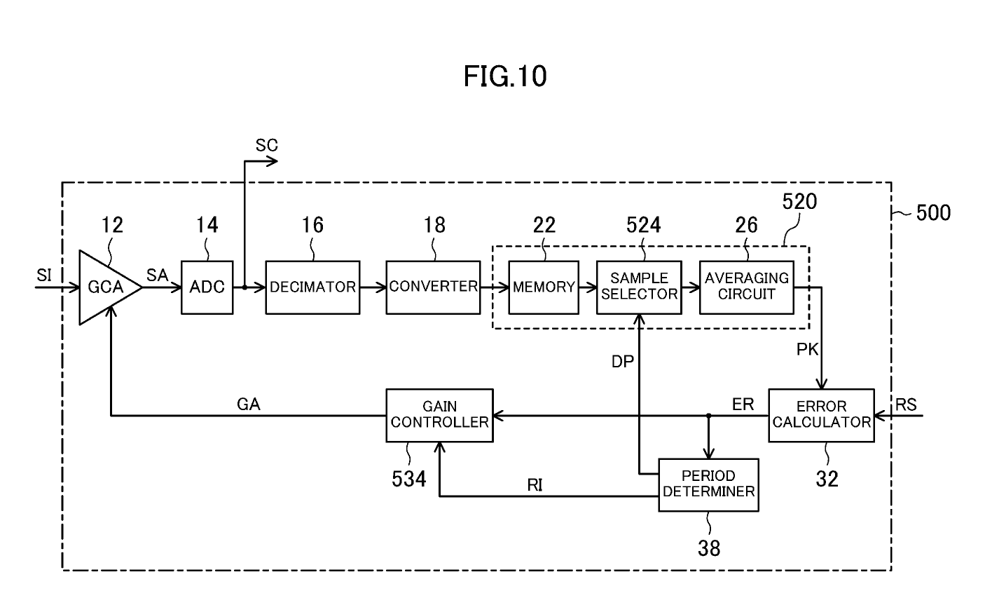

FIG. 10 is a block diagram illustrating still another example configuration of the automatic gain control device of FIG. 1. The automatic gain control device 500 of FIG. 10 is configured similarly to the automatic gain control device 100 of FIG. 1 except that the automatic gain control device 500 includes a peak detector 520 and a gain controller 534 instead of the peak detector 20 and the gain controller 34, and further includes a period determiner 38.

Although the above examples assume that the duration of the peak detection period and the period of updating the gain control signal GA (gain update interval) are constant, the duration of the peak detection period and the gain update interval do not need to be constant. For example, the duration of the peak detection period and the gain update interval may be changed based on the magnitude of the error signal ER. In general, since a next gain is updated based on the result of peak detection after a gain update, there is a relationship of (gain update interval)≧(the duration of the peak detection period). Thus, one gain update interval includes a peak detection period, and therefore the duration of the peak detection period and the gain update interval do not necessarily need to be the same.

The period determiner 38 determines an appropriate duration of the peak detection period DP and an appropriate gain update interval RI based on the magnitude of the error signal ER output from the error calculator 32. The peak detector 520 determines a peak level PK in each duration of the peak detection period DP determined by the period determiner 38. The gain controller 534 updates the gain control signal GA once in each gain update interval RI determined by the period determiner 38. The peak detector 520 and the gain controller 534 are similar to the peak detector 20 and the gain controller 34 except for the aforementioned operation.

For example, if the level of the input signal SI is significantly different from a reference value, that is, if the gain of the amplifier 12 is considerably high or considerably low, then the absolute value of the error signal ER is high. In such a case, the period determiner 38 decreases the duration of the peak detection period DP and the gain update interval RI. If the magnitude of the error signal ER is near zero, the period determiner 38 increases the duration of the peak detection period DP and the gain update interval RI. Thus, the value of the gain control signal GA and the gain of the amplifier 12 can be rapidly and smoothly converged even when the input signal level changes rapidly. The period determiner 38 may change the duration of the peak detection period DP and the gain update interval RI in inverse proportion to the magnitude of the error signal ER.

The peak detector 520 is configured similarly to the peak detector 20 of FIG. 1 except that the peak detector 520 includes a sample selector 524 instead of the sample selector 24. The sample selector 524 receives the duration of the peak detection period DP from the period determiner 38, and operates based on the duration of the peak detection period DP.

The sample selector 24 of FIG. 1 selects the values of the top X samples after removing the values of the top M samples from the values of the N samples held in the memory 22. Meanwhile, the sample selector 524 of FIG. 10 changes the number M to be removed based on the duration of the peak detection period DP. The other part of operation is similar to that of the sample selector 24. In general, a longer peak detection period causes noise to have larger effects, and thus the sample selector 524 increases the number M to be removed as the duration of the peak detection period DP increases. For example, the sample selector 524 changes the number M of the samples to be removed in proportion to the duration of the peak detection period DP. Thus, the effects of noise can be reduced even if the peak detection period is long.

Similarly, the automatic gain control device 200 of FIG. 3 may include the sample selector 524 and the gain controller 534 instead of the sample selector 24 and the gain controller 34, and may further include the period determiner 38.

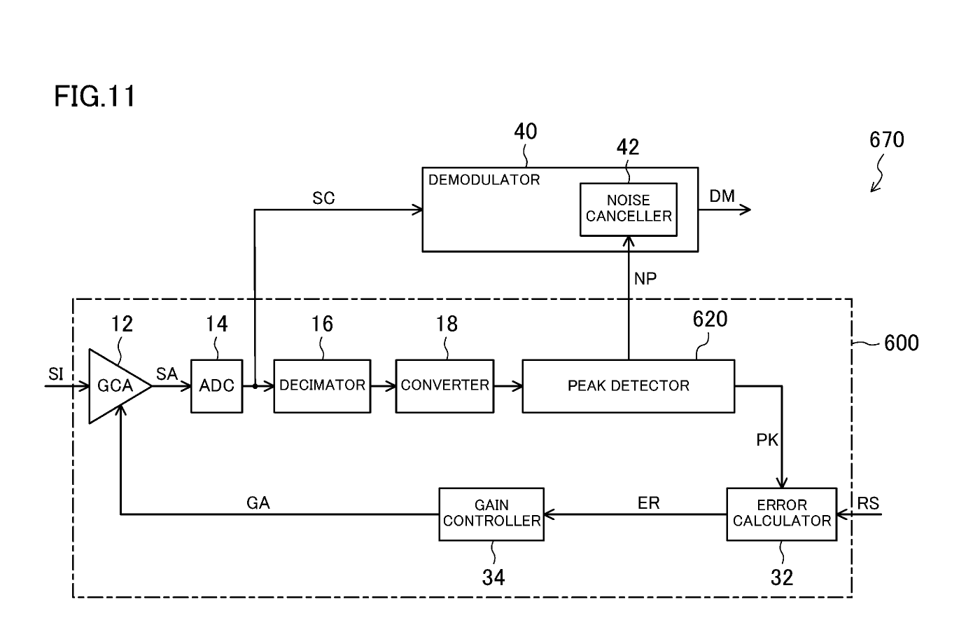

FIG. 11 is a block diagram illustrating an example configuration of a radio receiver according to an embodiment of the present invention. The radio receiver 670 of FIG. 11 includes an automatic gain control device 600 and a demodulator 40. The automatic gain control device 600 is configured similarly to the automatic gain control device 100 of FIG. 1 except that the automatic gain control device 600 includes a peak detector 620 instead of the peak detector 20.

The peak detector 620 is configured almost the same as the peak detector 20 of FIG. 1. For example, the memory included in the peak detector 620 determines the position (timing) of impulse noise, and outputs noise position information NP indicating the position of impulse noise. The memory determines the positions of sample values having higher values (e.g., M highest sample values S1-S7 in FIG. 2) as the positions of impulse noise. The peak detector 620 may be configured almost the same as the peak detectors 220 and 320 of FIGS. 3 and 7, and thus the maximum value detector 28 or 328 may determine the positions of sample values having higher values (e.g., the sample values S1 and S2 in FIG. 4) as the positions of impulse noise, and may output noise position information NP indicating the positions thereof.

The demodulator 40 demodulates a signal SC output from the ADC 14, and outputs an obtained demodulated signal DM. The demodulator 40 includes a noise canceller 42. The noise canceller 42 removes impulse noise from the signal SC of the demodulator 40 using the noise position information NP, and thus prevents the demodulated signal DM from being affected by the impulse noise. The noise canceller 42 can reliably find the position of impulse noise by using the noise position information NP, and thus the peak detector 620 can operate more efficiently than when the noise position information NP is not used.

The demodulator 40 does not necessarily need to include the noise canceller 42. Moreover, in FIG. 11, the radio receiver 670 may use any one of the automatic gain control devices 100, 200, 300, 400, and 500 instead of the automatic gain control device 600.

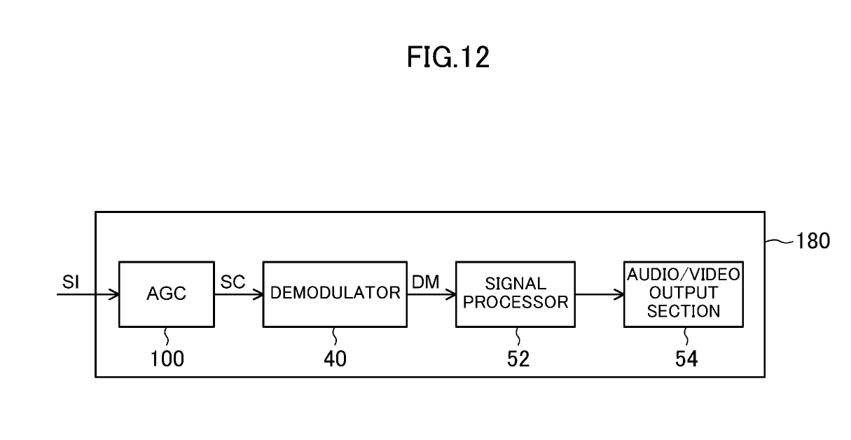

FIG. 12 is a block diagram illustrating an example configuration of an electronic device according to an embodiment of the present invention. The electronic device 180 of FIG. 12 includes the automatic gain control device 100, the demodulator 40, a signal processor 52, and an audio/video output section 54. The automatic gain control device 100 outputs a signal SC to the demodulator 40, and the demodulator 40 demodulates the signal SC, and outputs a demodulated signal DM. The signal processor 52 performs predetermined signal processing, such as decoding, on the demodulated signal DM, and outputs a processed signal. The audio/video output section 54 includes at least one of a display panel or a speaker, and at least displays video represented by the signal which has been processed by the signal processor 52 on the display panel, or outputs audio represented by the signal which has been processed by the signal processor 52 from the speaker.

Examples of the electronic device 180 include a radio receiver set and a television receiver set. In FIG. 12, the electronic device 180 may use any one of the automatic gain control devices 200, 300, 400, 500, and 600 instead of the automatic gain control device 100.

Although, in each of the examples described above, the automatic gain control device includes only one GCA, the automatic gain control device may further include another GCA coupled in series to the GCA. In other words, the automatic gain control device may include a plurality of GCAs coupled in series, in which case at least one of the plurality of GCAs is controlled in the manner described above.

Although the input and output signals of each of the automatic gain control devices have been described as real signals, these signals may be complex signals. For example, if an automatic gain control device is used in a receiver having a quadrature demodulator, a complex signal (an in-phase signal SII and a quadrature signal SIQ) output from the quadrature demodulator is used as the input signal to the automatic gain control device.

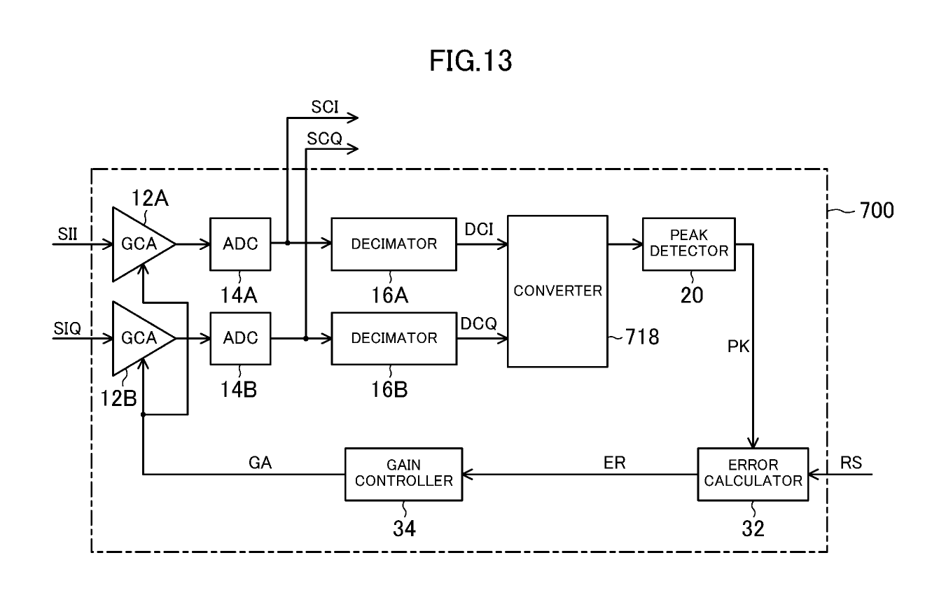

FIG. 13 is a block diagram illustrating an example configuration of an automatic gain control device to which a complex signal is input. The automatic gain control device 700 of FIG. 13 includes GCAs 12A and 12B, ADCs 14A and 14B, decimators 16A and 16B, a converter 718, a peak detector 20, an error calculator 32, and a gain controller 34.

The amplifiers 12A and 12B are similar to the amplifier 12 of FIG. 1 except that the signals SII and SIQ are respectively input thereto. The ADC 14A and 14B are similar to the ADC 14 of FIG. 1, and the decimators 16A and 16B are similar to the decimator 16 of FIG. 1. The ADC 14A outputs a converted signal SCI to the decimator 16A and to a demodulator circuit outside the automatic gain control device 700. The ADC 14B outputs a converted signal SCQ to the decimator 16B and to the demodulator circuit. The decimators 16A and 16B perform decimation in a similar manner to the decimator 16, and respectively output obtained signals DCI and DCQ to the converter 718.

The converter 718 includes a squaring circuit, calculates, for example, I²+Q² or °√(I²+Q²), and outputs the result to the peak detector 20. The peak detector 20, the error calculator 32, and the gain controller 34 are similar to those described referring to FIG. 1. Each of the automatic gain control devices 200, 300, 400, 500, and 600 may include, similarly to the automatic gain control device 700, the GCAs 12A and 12B, the ADCs 14A and 14B, the decimators 16A and 16B, and the converter 718.

Each function block described herein can typically be implemented in hardware. For example, each function block can be formed on a semiconductor substrate as a part of an integrated circuit (IC). Here, the term IC includes large-scale integrated circuit (LSI), application-specific integrated circuit (ASIC), gate array, field programmable gate array (FPGA), etc. As another alternative, a part or all of each function block can be implemented in software. For example, such a function block can be implemented by a processor and a program executed by the processor. In other words, each function block described herein may be implemented in hardware, software, or any combination of hardware and software.

As described above, according to the various embodiments of the present invention, reduction in the effects of impulse noise can be achieved by a relatively simple circuit configuration, and accordingly the present invention is useful for automatic gain control devices, car radio tuners using the automatic gain control devices, etc.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An automatic gain control device, comprising:
an amplifier configured to amplify an input signal based on a gain control signal, and to output an amplified signal;
a converter configured to convert the amplified signal into a converted signal having a value corresponding to an absolute value of the amplified signal;
a peak detector configured to
remove, during a peak detection period, from values of the converted signal, a predetermined number of values which include a maximum value, and
determine a peak level of the converted signal after the removing;
an error calculator configured to calculate an error between the peak level and a reference signal, and to output the error as an error signal; and
a gain controller configured to update the gain control signal based on the error signal, and to output an updated gain control signal.

2. The automatic gain control device of claim 1, wherein
the peak detector includes
a memory configured to receive the converted signal, and to hold N highest values (where N is an integer greater than or equal to 2) among the values of the converted signal input during the peak detection period,
a sample selector configured to select X values, from (M+1)-th to (M+X)-th highest values (where M is a natural number satisfying M<N, and X is a natural number satisfying X≦N−M), from the values held in the memory, and
an averaging unit configured to average the values selected by the sample selector, and to output an obtained average as the peak level.

3. The automatic gain control device of claim 2, wherein
the peak detector further includes a maximum value detector configured to determine a maximum value in the values of the converted signal, and to output the maximum value, in each period of a predetermined duration which is shorter than the peak detection period, and
the memory receives the value output from the maximum value detector.

4. The automatic gain control device of claim 2, wherein
when the memory receives a new value, the memory determines whether to hold the new value or not, and if a maximum value of the held values is updated with the new value, a predetermined number of values input immediately thereafter are not held.

5. The automatic gain control device of claim 1, wherein
the peak detector includes
a memory configured to receive the converted signal converted by the converter, and to hold values input during a period of a predetermined duration which is shorter than the peak detection period,
a sample selector configured to select, from the values held in the memory, values other than a predetermined number of values which include a maximum value and values before and after the maximum value,
a maximum value detector configured to determine a maximum value in the values selected by the sample selector, and
an averaging unit configured to average maximum values determined by the maximum value detector within the peak detection period, and to output an obtained average as the peak level.

6. The automatic gain control device of claim 1, further comprising:
a low-pass filter configured to smooth the error signal, and to output a smoothed signal,
wherein
the gain controller updates the gain control signal based on the smoothed signal, and outputs the updated gain control signal.

7. The automatic gain control device of claim 1, further comprising:
a period determiner configured to determine a duration of the peak detection period based on a magnitude of the error signal,
wherein
the peak detector determines the peak level in each peak detection period, and
the gain controller updates the gain control signal in each period including the peak detection period.

8. The automatic gain control device of claim 7, wherein
the peak detector changes the predetermined number based on the duration of the peak detection period.

9. The automatic gain control device of claim 1, further comprising:
another amplifier coupled in series with the amplifier.

10. A receiver, comprising:
an automatic gain control device; and
a demodulator,
wherein
the automatic gain control device includes
an amplifier configured to amplify an input signal based on a gain control signal, and to output an amplified signal,
a converter configured to convert the amplified signal into a converted signal having a value corresponding to an absolute value of the amplified signal,
a peak detector configured to
remove, during a peak detection period, from values of the converted signal, a predetermined number of values which include a maximum value,
determine a peak level of the converted signal after the removing, and
output noise position information indicating a timing of impulse noise,
an error calculator configured to calculate an error between the peak level and a reference signal, and to output the error as an error signal, and
a gain controller configured to update the gain control signal based on the error signal, and to output an updated gain control signal;
the demodulator includes a noise canceller, and demodulates the amplified signal, and outputs a demodulated signal; and
the noise canceller removes noise from a signal in the demodulator using the noise position information.

11. An electronic device, comprising:
the receiver of claim 10;
a signal processor configured to perform predetermined signal processing on the demodulated signal output from the receiver, and to output a processed signal; and
an output section configured to, at least:
display video represented by the processed signal, or
output audio represented by the processed signal.

12. An automatic gain control method, comprising:
amplifying an input signal by an amplifier based on a gain control signal, and obtaining an amplified signal;
converting the amplified signal into a converted signal having a value corresponding to an absolute value of the amplified signal;
removing, during a peak detection period, from values of the converted signal, a predetermined number of values which include a maximum value;
determining a peak level of the converted signal after the removing;
calculating an error between the peak level and a reference signal to output the error as an error signal; and
updating the gain control signal based on the error signal.
